(19) United States
(12) Patent Application Publication
(10) Pub. No.: US 2018/0181296 A1
(43) Pub. Date: Jun. 28, 2018

(54) METHOD AND DEVICE FOR PROVIDING ISSUE CONTENT

(71) Applicant: Samsung Electronics Co., Ltd., Suwon-si, Gyeonggi-do (KR)

(72) Inventors: Dong-hyuk LEE, Seoul (KR); Seong-taek HWANG, Pyeongtaek-si (KR); Sang-ho KIM, Hwaseong-si (KR); Dong-chang LEE, Suwon-si (KR); Won-hee LEE, Suwon-si (KR); Ho-young JUNG, Seoul (KR)

(21) Appl. No.: 15/735,431

(22) PCT Filed: Jun. 10, 2016
(86) PCT No.: PCT/KR2016/006166

§ 371 Date: Dec. 11, 2017

(30) Foreign Application Priority Data
Jun. 11, 2015 (KR) 10-2015-0082571

(51) Int. Cl. G06F 3/0488; G06F 3/0482; G06F 3/0483; G06F 17/27

(52) U.S. Cl. CPC G06F 3/04883; G06F 17/2765; G06F 3/0483; G06F 3/0482

(57) ABSTRACT

Provided are a device and a method for providing question content. In an example embodiment, the method includes: acquiring handwriting data input by a user to a screen of a device; determining at least one main keyword from the handwriting data based on a predetermined criterion; and providing the user with question content based on the determined at least one main keyword.

### TECHNICAL FIELD

The present disclosure relates to a device and a method for providing a user with question content, in particular, to a device and a method for providing a user with question content based on handwriting data input to the device.

### BACKGROUND ART

It is difficult for a user to carry a keyboard and a mouse which are used as main input devices for a desktop computer. As hardware technology has developed, various input devices have become available for electronic devices. Technology for interaction with a user has been extensively researched. For example, touch sensing technology has been given much attention since it can provide a user with an intuitive interface.

Touch sensing technology may be used to recognize a touch input as well as handwriting of a user. Handwriting recognition technology may be used to recognize handwriting of a user which has been input by a finger or a stylus, and it can provide a user experience of writing on a paper. Accordingly, a user may store a note in a device similar to writing on a paper. Such user experience may improve productivity of students and teachers in an educational environment.

Students may take notes in a class, and perform problem solving exercises to test their levels. Conventional devices merely function as ebook readers, and fail to improve learning efficiency of students. Accordingly, technology for improving learning efficiency is needed.

### DISCLOSURE

### Technical Problem

Various embodiments may provide a device and a method for providing a user with question content based on handwriting data input to the device.

### Technical Solution

In an example embodiment, a method of providing a user with question content is provided, the method comprising: acquiring handwriting data input to a screen of a device by a user; determining at least one main keyword from the handwriting data based on a predetermined criterion; and providing the user with question content based on the determined at least one main keyword.

In an example embodiment, the determining the at least one main keyword comprises: determining, as the at least one main keyword, at least one keyword highlighted by the user among keywords included in the acquired handwriting data.

In an example embodiment, the acquired handwriting data comprises at least one bullet point, and the determining the at least one main keyword comprises determining, as the at least one main keyword, at least one keyword located in a predetermined range from the at least one bullet point.

In an example embodiment, the method further includes determining at least one description keyword related to the determined at least one main keyword from the acquired handwriting data based on a predetermined criterion, and the question content is provided based on the determined main keyword and the determined description keyword.

In an example embodiment, the providing the question content comprises: making invisible the determined at least one main keyword or the determined at least one description keyword.

In an example embodiment, the determined at least one description keyword is located in a predetermined range from the determined at least one main keyword.

In an example embodiment, the acquired handwriting data comprises at least one punctuation mark, and the determining the at least one description keyword comprises determining, as the at least one description keyword, at least one keyword located in a predetermined range from the at least one punctuation mark.

In an example embodiment, the method further includes retrieving at least one description keyword related to the determined at least one main keyword from a description keyword database by comparing the determined at least one main keyword and the description keyword database, and the question content is provided based on the determined at least one main keyword and the selected description keyword.

In an example embodiment, the question content is retrieved from a question content database by comparing the determined at least one main keyword and the question content database.

In an example embodiment, the acquired handwriting data includes text data converted from the acquired handwriting data.

In an example embodiment, the at least one main keyword is determined based on text analysis of the text data converted from the acquired handwriting data.

In an example embodiment, the acquired handwriting data is divided by a plurality of segments based on a predetermined criterion, and the question content is provided based on the plurality of segments.

In an example embodiment, the at least one main keyword is selected among keywords by the user in the acquired handwriting data.

In an example embodiment, the handwriting data is input to a loaded ebook content, and the determining the at least one main keyword comprises determining, as the at least one main keyword, at least one keyword highlighted by the user in the ebook content.

In an example embodiment, the determining the at least one main keyword comprises: determining the at least one main keyword based on an attribute of handwriting input in the acquired handwriting data.

In an example embodiment, the at least one main keyword is made invisible after a certain period based on the attribute of the handwriting input.

In an example embodiment, the providing the question content includes made making invisible the determined at least one main keyword.

In an example embodiment, the question content is provided to the user by audio.

In an example embodiment, the method further includes: receiving an answer input of the user to the question content; and determining frequency of providing the question content based on the answer input of the user.

In an example embodiment, the method further includes determining frequency of providing the question content based on an attribute of the determined at least one main keyword.

In an example embodiment, a device for providing a user with question content is provided, the device comprising: a user input interface configured to acquire handwriting data input to a screen of the device by a user; a processor configured to: determine at least one main keyword from the handwriting data based on a predetermined criterion; and provide the user with question content based on the determined at least one main keyword.

In an example embodiment, the determined the at least one main keyword is at least one keyword highlighted by the user in the acquired handwriting data.

In an example embodiment, the acquired handwriting data comprises at least one bullet point, and the processor is further configured to determine, as the at least one main keyword, at least one keyword located in a predetermined range from the at least one bullet point.

In an example embodiment, the processor is further configured to determine at least one description keyword related to the determined at least one main keyword from the acquired handwriting data based on a predetermined criterion, and the question content is provided based on the determined main keyword and the determined description keyword.

In an example embodiment, the processor is further configured to make invisible the determined at least one main keyword or the determined at least one description keyword.

In an example embodiment, the determined at least one description keyword is located in a predetermined range from the determined at least one main keyword.

In an example embodiment, the acquired handwriting data comprises at least one punctuation mark, and the processor is further configured to determine, as the at least one description keyword, at least one keyword located in a predetermined range from the at least one punctuation mark.

In an example embodiment, the processor is further configured to retrieve at least one description keyword related to the determined at least one main keyword from a description keyword database by comparing the determined at least one main keyword and the description keyword database, and the question content is provided based on the determined at least one main keyword and the selected description keyword.

In an example embodiment, the question content is retrieved from a question content database by comparing the determined at least one main keyword and the question content database.

In an example embodiment, the acquired handwriting data includes text data converted from the acquired handwriting data.

In an example embodiment, the at least one main keyword is determined based on text analysis of the text data converted from the acquired handwriting data.

In an example embodiment, the acquired handwriting data is divided by a plurality of segments based on a predetermined criterion, and the question content is provided based on the plurality of segments.

In an example embodiment, the at least one main keyword is selected among keywords by the user in the acquired handwriting data.

In an example embodiment, the handwriting data is input to a loaded ebook content, and the processor is further configured to determine, as the at least one main keyword, at least one keyword highlighted by the user in the ebook content.

In an example embodiment, the processor is further configured to determine the at least one main keyword based on an attribute of handwriting input in the acquired handwriting data.

In an example embodiment, the at least one main keyword is made invisible after a certain period based on the attribute of the handwriting input.

In an example embodiment, the processor is further configured to make invisible the determined at least one main keyword.

In an example embodiment, the question content is provided to the user by audio.

In an example embodiment, the processor is further configured to receive an answer input of the user to the question content; and determine frequency of providing the question content based on the answer input of the user.

In an example embodiment, the processor is further configured to determine frequency of providing the question content based on an attribute of the determined at least one main keyword.

In an example embodiment, a computer-readable recording medium having recorded thereon a program executable by a computer for performing the method is provided.

### DESCRIPTION OF DRAWINGS

FIG. 1 illustrates an example of providing question content.

FIG. 2 illustrates a flowchart of a method of providing question content based on handwriting data input to a device, according to an exemplary embodiment.

FIG. 3 is a drawing for explaining a main keyword determined from handwriting data, according to an example embodiment.

FIG. 4 is a drawing for explaining a main keyword determined from handwriting data based on a bullet point, according to an example embodiment.

FIG. 5 illustrates an example of providing question content.

FIG. 6 is a drawing for explaining a description keyword determined from handwriting data, according to an example embodiment.

FIG. 7 illustrates an example of providing question content.

FIG. 8 is a drawing for explaining a main keyword selected by a user, according to an example embodiment.

FIG. 9 is a drawing for explaining a main keyword determined based on an attribute of handwriting input by a user, according to an example embodiment.

FIG. 10 is a drawing for explaining a main keyword determined based on text analysis of handwriting data, according to an example embodiment.

FIGS. 11A, 11B, 11C, and 11D illustrate an example of handwriting data divided into a plurality of segments, according to an example embodiment.

FIGS. 12A, 12B, and 12C illustrate an example of question content provided based on segments.

FIG. 13 is a drawing for explaining a main keyword determined from ebook content.

FIG. 14 illustrates a flowchart of a method of determining a frequency of question content based on an answer input in response to the question content, according to an example embodiment.

FIG. 15 and FIG. 16 illustrate an example device.

### MODE OF INVENTION

Reference will now be made in detail to embodiments, examples of which are illustrated in the accompanying drawings. In this regard, the present embodiments may have different forms and should not be construed as being limited to the descriptions set forth herein. However, the exemplary embodiments may be realized in different forms, and are not limited to the embodiments in the present disclosure. In the accompanying drawings, like reference numerals refer to like elements throughout.

All terms including descriptive or technical terms which are used herein should be construed as having meanings that are obvious to one of ordinary skill in the art. However, the terms may have different meanings according to the intention of one of ordinary skill in the art, precedent cases, or the appearance of new technologies. Also, some terms may be arbitrarily selected by the applicant, and in this case, the meaning of the selected terms will be described in detail in the detailed description. Thus, the terms used herein have to be defined based on the meaning of the terms together with the description throughout the specification.

In the present disclosure, it should be understood that the terms “comprises,” “comprising,” “including,” and “having” are inclusive and therefore specify the presence of stated features or components, but do not preclude the presence or addition of one or more other features or components. In the present disclosure, the term such as “ . . . unit” or “ . . . module” should be understood as a unit in which at least one function or operation is processed and may be embodied as hardware, software, or a combination of hardware and software.

It should be understood that, although the terms “first,” “second,” etc. may be used herein to describe various elements, and these elements should not be limited by these terms. These terms are used to distinguish one element from another. For example, a first element may be termed a second element within the technical scope of an exemplary embodiment.

Terms used herein will now be briefly described and then one or more exemplary embodiments will be described in detail.

In the present disclosure, handwriting data is generated in response to a user's handwriting on a touch device such as a touch pad, a touch screen display, etc. The handwriting data may include a combination of stroke inputs. A stroke input may include a series of point inputs arranged in a time sequence along a moving route of a pointer such as a finger or a stylus. The stroke input may be input by a user continuously applying an input to a device until the input is released. The handwriting data may be displayed as drawn by the user.

The handwriting data may be converted to text data by an optical character recognition (OCR) unit. Accordingly, the handwriting data may include text data which is converted from the handwriting data.

In the present disclosure, a keyword may be referred to as a group of numbers, characters, and/or symbols, which may be identified in the handwriting data based on empty spaces having a certain size. For example, a keyword may be identified in a sentence based on spaces between words. An equation may be identified as a keyword, or a series of numbers, characters, and/or symbols may be identified as a keyword in the equation.

A keyword may be a combination of stroke inputs, and may include text converted from the keyword.

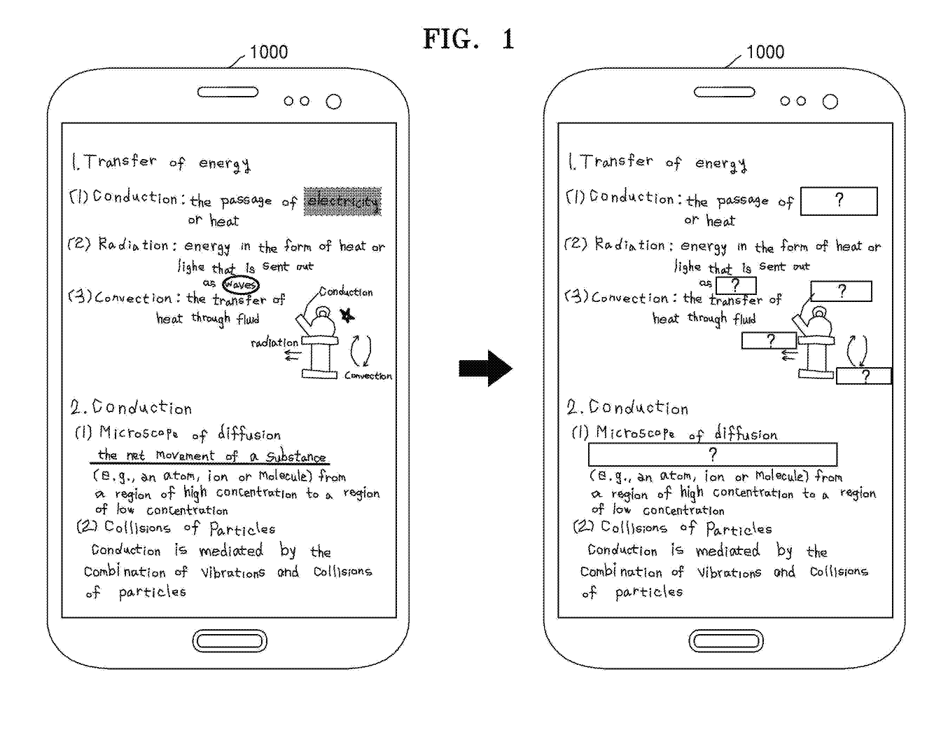

FIG. 1 illustrates an example of providing question content.

Referring to FIG. 1, a device 1000 may receive handwriting data input by a user, and display the handwriting data on a screen of the device 1000. The handwriting data may include numbers, characters, symbols, drawings, and tables drawn by the user. The device 1000 may provide a user with question content based on the handwriting data input by the user.

In an example embodiment, handwriting data may be input by a user, but is not limited thereto. For example, the device 1000 may receive handwriting data from another device which has received the handwriting data input by a user.

The device 1000 may be a smartphone, a tablet, a personal computer (PC), a television (TV), a smart TV, a cell phone, a personal digital assistant (PDA), a laptop, a media player, a micro sever, a Global Positioning System (GPS) device, an e-book reader, a digital multimedia broadcasting (DMB) device, a navigation device, a kiosk, an MP3 player, a digital camera, a mobile device, or a non-mobile device, but is not limited thereto.

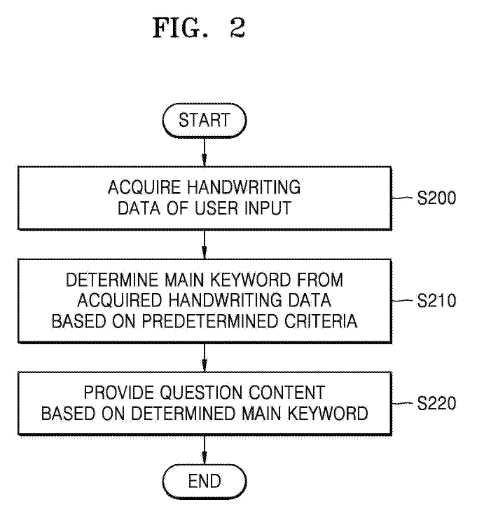

FIG. 2 illustrates a flowchart of a method of providing question content based on handwriting data input to a device, according to an exemplary embodiment.

Referring to FIG. 2, in operation S200, the device 1000 may acquire handwriting data input by a user, and the handwriting data may be input by touching a screen of the device 1000. In an example embodiment, the handwriting data may include numbers, characters, symbols, drawings, and tables, but is not limited thereto.

In operation S210, the device 1000 may determine a main keyword from the acquired handwriting data based on a predetermined criterion. In an example embodiment, the handwriting data may include a plurality of keywords, and at least one of the plurality of keywords may be determined as the main keyword. In an example embodiment, the main keyword may include two or more keywords.

In operation S220, the device 1000 may provide a user with question content based on the determined main keyword. Question content may be provided in various ways. In an example embodiment, question content may be provided by making invisible the determined main keyword in the handwriting data to cause a user to guess the main keyword. Here, making the main keyword invisible may be performed by removing the main keyword from the handwriting data, by displaying the main keyword as a blank, or by overlaying an image on the main keyword.

In an example embodiment, question content may be provided to a user as a voice output to allow a user to study without viewing a screen of the device 1000. When handwriting data includes text data which is converted from the handwriting data, text to speech (TTS) may be performed on the text data for a voice output. For example, the main keyword may be output as ‘blah blah blah’, and other keywords may be output as text recognized. For example, when ‘Conduction’ is determined as a main keyword in handwriting data, a voice question saying ‘What is Conduction’ may be output to a user.

In an example embodiment, question content may be selected from a question content database by comparing the determined main keyword and the question content database.

In an example embodiment, question content may correspond to a plurality of indexes, and an index may correspond to a plurality of pieces of question content.

In an example embodiment, when the question content database stores an index corresponding to the determined main keyword, question content corresponding to the index may be provided to a user. In an example embodiment, when the index corresponds to a plurality of pieces of question content, the plurality of pieces of question content may be provided to a user. In an example embodiment, an index corresponding to a main keyword may include an index matched with the main keyword by more than a certain threshold.

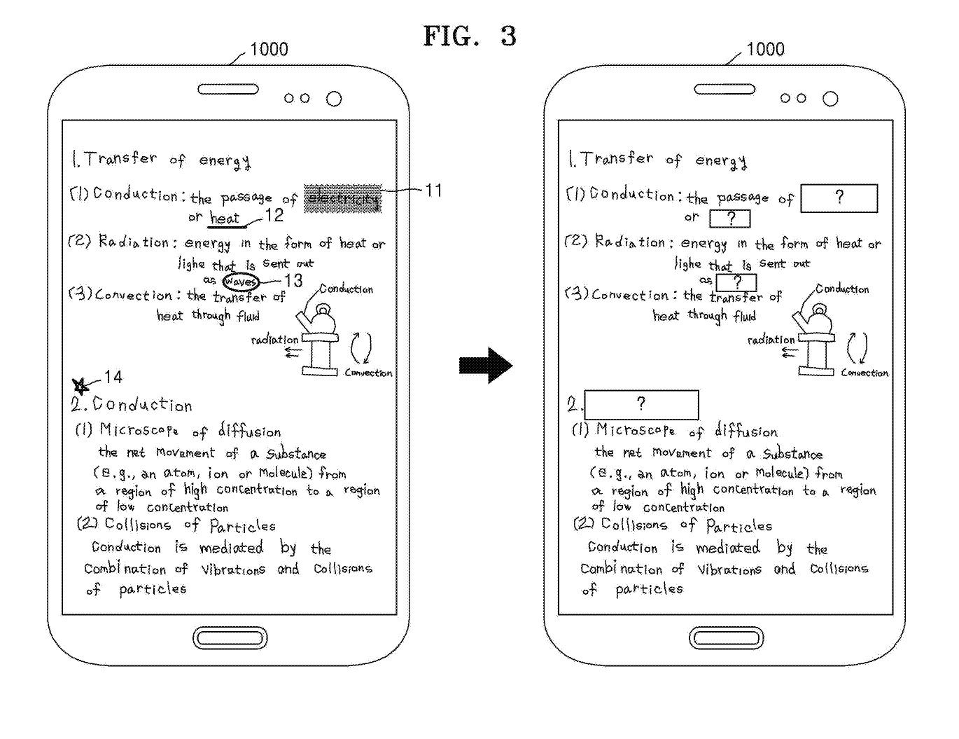

FIG. 3 is a drawing for explaining a main keyword determined from handwriting data, according to an example embodiment.

Referring to FIG. 3, a keyword highlighted by a user in handwriting data may be determined as a main keyword. In an example embodiment, highlighting may be included in the handwriting data to stress a certain part of the handwriting data. For example, highlighting may include a highlight 11, an underline 12, a circle 13, a star 14, and a box, but is not limited thereto.

In an example embodiment, when a certain part is highlighted by the highlight 11 in the handwriting data, a keyword located on or under the highlight 11 may be determined as a main keyword. For example, referring to FIG. 3, ‘electricity’ which is located on or under the highlight 11 may be determined as a main keyword.

In an example embodiment, when a certain part is highlighted by the underline 12 in the handwriting data, a keyword located above the underline 12 may be determined as a main keyword. For example, referring to FIG. 3, ‘heat’ which is located above the underline 12 may be determined as a main keyword.

In an example embodiment, when a certain part is highlighted by the circle 13 or box in the handwriting data, a keyword located in the circle 13 or box, or a keyword intersecting a stroke of the circle 13 or box may be determined as a main keyword. For example, referring to FIG. 3, ‘waves’ which is located in the circle 13 may be determined as a main keyword.

In an example embodiment, when a certain part is highlighted by the star 14 in the handwriting data, a keyword intersecting a stroke of the star 14, or a keyword adjacent to the star 14 may be determined as a main keyword. For example, referring to FIG. 3, ‘Conduction’ which is adjacent to the star 14 may be determined as a main keyword.

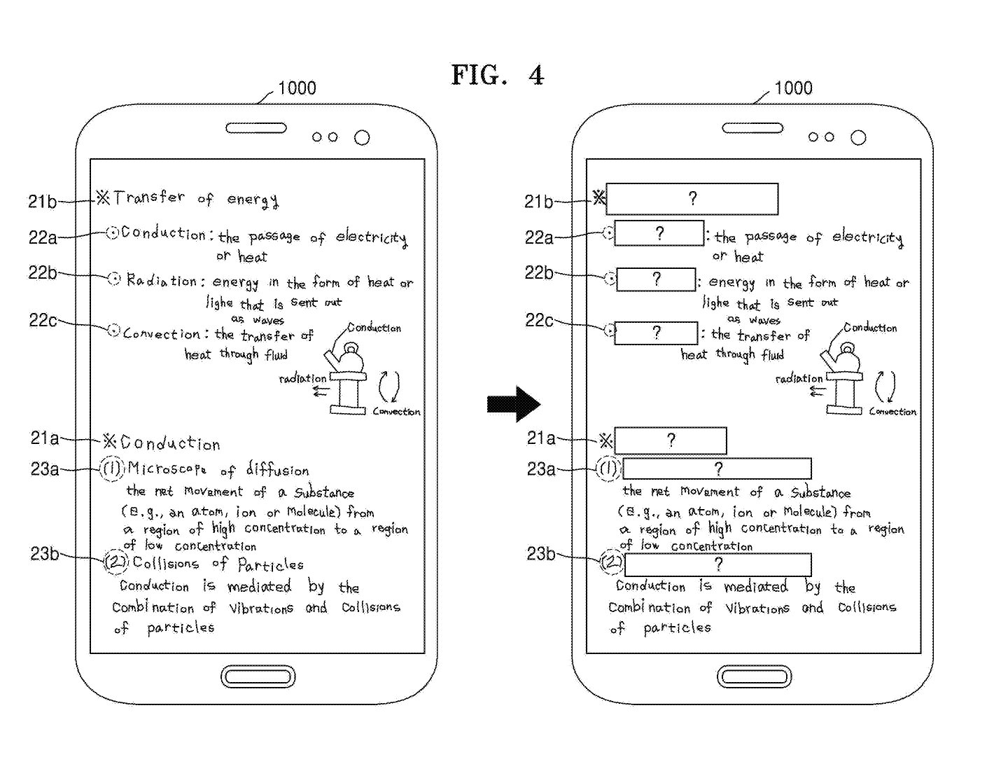

FIG. 4 is a drawing for explaining a main keyword determined from handwriting data based on a bullet point, according to an example embodiment.

Referring to FIG. 4, handwriting data may include a bullet point, and a keyword located within a predetermined range of the bullet point may be determined as a main keyword. In an example embodiment, the bullet point may include a symbol, number, and character, but is not limited thereto.

In an example embodiment, when handwriting data includes a symbol bullet point, a keyword closest to the symbol bullet point may be determined as a main keyword. For example, referring to FIG. 4, ‘Conduction’ which is closest to a symbol bullet point 21 (※) may be determined as a main keyword.

In an example embodiment, a series of keywords next to a bullet point may be determined as a main keyword. The series of keywords may end before a line break. For example, referring to FIG. 4, ‘Transfer of energy’ next to the bullet point 21 (※) may be determined as a main keyword.

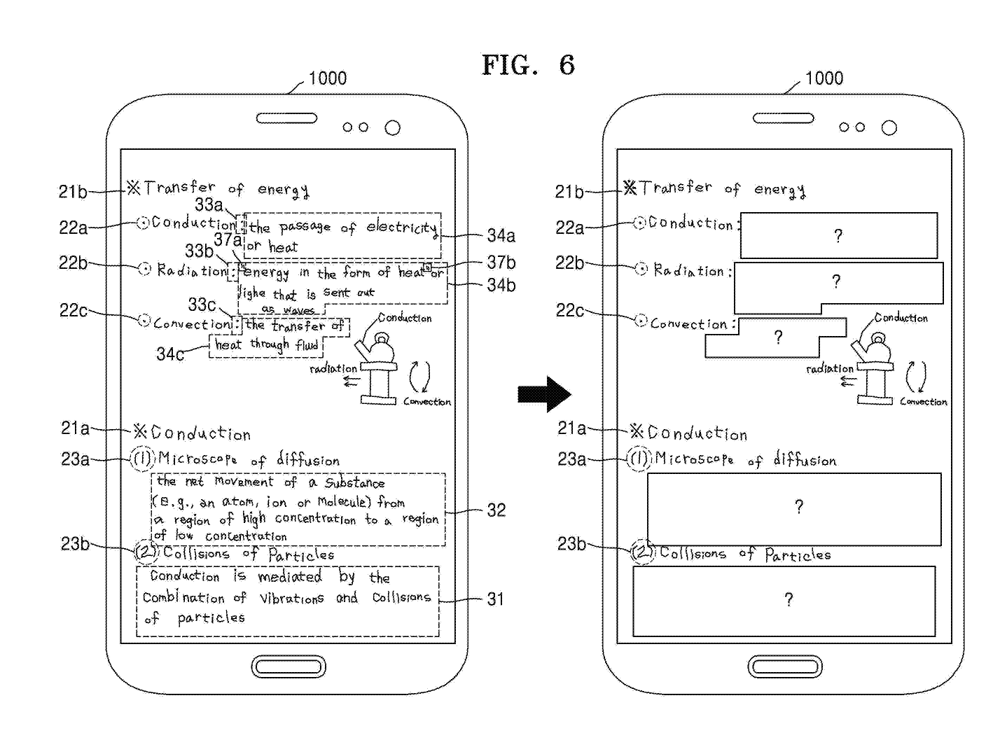

In an example embodiment, a series of keywords next to a bullet point may be determined as a main keyword. The series of keywords may end before a punctuation mark. For example, referring to FIG. 4, ‘Conduction’, ‘Radiation’, and ‘Convection’ between bullet points 22a, 22b, and 22c (●) and punctuation marks (:) may be respectively determined as main keywords. Explanation of punctuation marks will be described later below by referring FIG. 6.

In an example embodiment, a number bullet point may include a number, and a period point, a comma, and brackets near the number. A character bullet point may include a character, and a period point, a comma, and brackets near the character. In an example embodiment, when handwriting data includes a number bullet point, a keyword closest to a number or a symbol included in the number bullet point may be determined as a main keyword. In an example embodiment, a series of keywords next to a bullet point may be determined as a main keyword. The series of keywords may end before a punctuation mark or a line break. For example, referring to FIG. 4, ‘Microscope of diffusion’ and ‘Collision of Particles’ between bullet points 23a and 23b and line breaks may be respectively determined as main keywords.

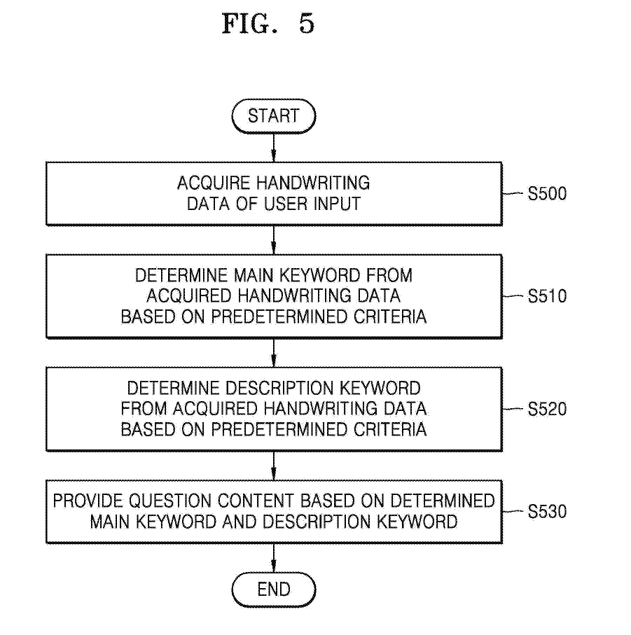

FIG. 5 illustrates an example of providing question content.

Referring to FIG. 5, in operation S500, the device 1000 may acquire handwriting data input by a user, and the handwriting data may be input by touching a screen of the device 1000. In an example embodiment, the handwriting data may include numbers, characters, symbols, drawings, and tables, but is not limited thereto.

In operation S510, the device 1000 may determine a main keyword from the acquired handwriting data based on a predetermined criterion. In an example embodiment, the handwriting data may include a plurality of keywords, and at least one of the plurality of keywords may be determined as the main keyword. In an example embodiment, the main keyword may include two or more keywords.

In operation S520, the device 1000 may determine a description keyword related to the determined main keyword. In an example embodiment, the handwriting data may include a plurality of keywords, and one of the plurality of keywords may be determined as the description keyword related to the main keyword. In an example embodiment, the description keyword may include two or more keywords.

In operation S530, the device 1000 may provide a user with question content based on the determined main keyword and the determined description keyword. In an example embodiment, question content may be provided by various ways. For example, question content may be provided by making invisible the determined main keyword or description keyword in the handwriting data to cause a user to guess what the main keyword is or to guess what the main keyword is referring to.

In an example embodiment, question content may be provided as a multiple choice question. In an example embodiment, description keywords may be used as options in a multiple choice question for a main keyword. For example, question content may include a question asking “Which one of the following is a correct explanation of ‘main keyword’”?, and, as options, a description keyword related to the main keyword and other description keywords.

In an example embodiment, main keywords may be used as options in a multiple choice question for a description keyword. For example, question content may include a question asking “What does ‘description keyword’ refer to?”, and, as options, a main keyword related to the description keyword and other main keywords.

In an example embodiment, question content may be provided to a user as a voice output to allow a user to study without viewing a screen of the device 1000. When handwriting data includes text data which is converted from the handwriting data, text to speech (TTS) may be performed on the text data for a voice output.

FIG. 6 is a drawing for explaining a description keyword determined from handwriting data, according to an example embodiment.

Referring to FIG. 6, handwriting data may include a bullet point, and a keyword closest to the bullet point may be determined as a main keyword. Furthermore, a description keyword related to the determined main keyword may be located within a predetermined range of the determined main keyword.

For example, keywords next to the determined main keyword may be determined as the description keyword. Here, a concept of “next” and “previous” is based on a text orientation such as from left to right, and from top to bottom, but is not limited thereto since text orientation may change according to a language and a user's habit.

Main keywords determined in FIG. 6 are the same as in FIG. 4. Referring to FIG. 6, keywords 31 next to the determined main keyword may be determined as the description keyword related to the determined main keyword.

In an example embodiment, when handwriting data includes a plurality of bullet points, a description keyword related to a main keyword which is determined based on a first bullet point may start from a keyword next to the determined main keyword, and end before a second bullet point. For example, referring to FIG. 6, a description keyword 32 related to a main keyword ‘Microscope of diffusion’ which is determined based on a first bullet point 23a may start from a keyword next to the determined main keyword, and end before a second bullet point 23b.

In an example embodiment, when handwriting data includes a punctuation mark, keywords located in a predetermined range from the punctuation mark may be determined as a description keyword. A punctuation mark may include a colon (:), a semi-colon (;), a dash (-) a hyphen (-), a tilde (˜), double quotes (“ ”), single quotes (‘ ’), angle brackets (< >), round brackets (( ), curly brackets ({ }), square brackets ([ ]), but is not limited thereto.

In an example embodiment, when handwriting data includes a punctuation mark such as a colon, a semi-colon, a dash, a hyphen, or tilde, keywords next to the punctuation mark may be determined as a description keyword related to a main keyword which is previous to and closest to the punctuation mark. For example, referring to FIG. 6, keywords 34a next to a colon 33a may be determined as a description keyword related to a main keyword ‘Conduction’ which is previous to and closest to the colon 33a. Likewise, keywords 34b next to a colon 33b may be determined as a description keyword related to a main keyword ‘Radiation’ which is previous to and closest to the colon 33b, and keywords 34c next to a colon 33c may be determined as a description keyword related to a main keyword ‘Convection’ which is previous to and closest to the colon 33c.

In an example embodiment, when handwriting data includes punctuation marks such as double quotes, single quotes, angle brackets, round brackets, curly brackets, or square brackets, keywords between the punctuation marks may be determined as a description keyword related to a main keyword which is previous to and closest to the punctuation marks, that is, a previous punctuation mark of the punctuation marks. For example, referring to FIG. 6, keywords ‘energy in the form of heat’ between double quotes 37a and 37b may be determined as a description keyword related to a main keyword which is previous to and closest to a double quote 37a.

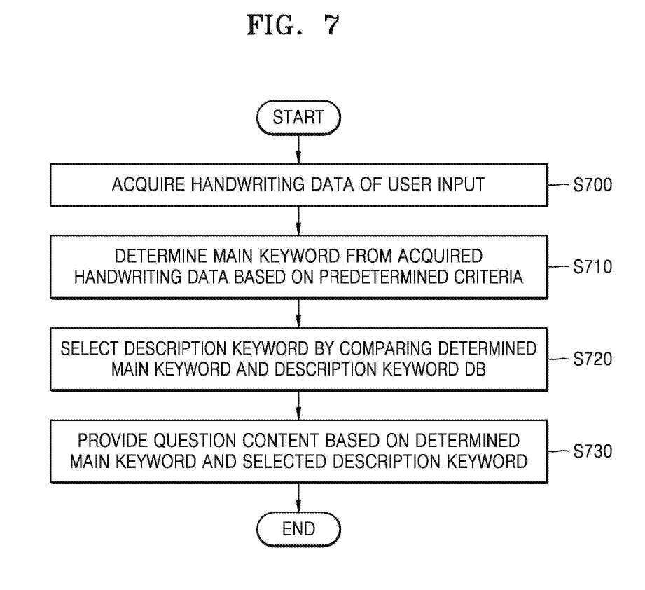

FIG. 7 illustrates an example of providing question content.

Referring to FIG. 7, in operation S700, the device 1000 may acquire handwriting data input by a user, and the handwriting data may be input by touching a screen of the device 1000. In an example embodiment, the handwriting data may include numbers, characters, symbols, drawings, and tables, but is not limited thereto.

In operation S710, the device 1000 may determine a main keyword from the acquired handwriting data based on a predetermined criterion. In an example embodiment, the handwriting data may include a plurality of keywords, and at least one of the plurality of keywords may be determined as the main keyword. The main keyword may include two or more keywords.

In operation S720, the device 1000 may select in a description keyword database a description keyword related to a main keyword by comparing the main keyword and the description keyword database.

In an example embodiment, a keyword may correspond to a plurality of indexes in a description keyword database, and an index may correspond to a plurality of keywords.

In an example embodiment, when the description keyword database stores an index matched with a main keyword, a keyword corresponding to the index may be determined as a description keyword related to the main keyword. In an example embodiment, when an index corresponds to a plurality of keywords, all of the keywords may be determined as a description keyword related to the main keyword. In an example embodiment, an index corresponding to a main keyword may include an index matched with the main keyword more than a certain threshold.

In an example embodiment, a description keyword database may be included in the device 1000, but connected to the device 1000 via a network.

In an example embodiment, the handwriting data may include a plurality of keywords, and the device 1000 may determine at least one of the plurality of keywords as the description keyword related to the main keyword.

In operation S730, the device 1000 may provide a user with question content based on the determined main keyword and the selected description keyword. In an example embodiment, question content may be provided by various ways. For example, a description keyword may be displayed as question content to cause a user to guess what the description keyword explains.

In an example embodiment, question content may be provided as a multiple choice question. In an example embodiment, description keywords selected from a description keyword database may be used as options in a multiple choice question for a main keyword. For example, question content may include a question saying “Which one of the following is correct explanation of ‘a main keyword’, and, as options, a description keyword related to the main keyword and other description keywords. In an example embodiment, keywords randomly selected from the description keyword database may be used as the options. Keywords corresponding to an index matched with a main keyword more than a certain threshold may be used as the options. Keywords related to a description keyword may be used as the options.

In an example embodiment, main keywords may be used as options in a multiple choice question for a description keyword selected from a description keyword database. For example, question content may include a question saying “What does ‘a description keyword’ explain”, and, as options, a main keyword related to the description keyword and other main keywords. In an example embodiment, question content may include indexes randomly selected from a description keyword database, indexes matched with a main keyword more than a certain threshold, or other indexes corresponding to a description keyword as the options.

In an example embodiment, question content may be provided to a user as a voice output to allow a user to study without viewing a screen of the device 1000. When handwriting data includes text data which is converted from the handwriting data, text to speech (TTS) may be performed on the text data for a voice output.

FIG. 8 is a drawing for explaining a main keyword selected by a user, according to an example embodiment.

Referring to FIG. 8, a keyword selected by a user in handwriting data may be determined as a main keyword. In an example embodiment, a keyword on or closest to an input point of a user may be determined as a main keyword. For example, referring to FIG. 8, ‘electricity’ and ‘heat’ on inputs 41a and 41b may be determined as a main keyword.

In an example embodiment, when a user input extends to the right, keywords along the user input may be determined as a main keyword. For example, referring to FIG. 8, “energy in the form of heat” along the user input 42 extending to the right may be determined as a main keyword.

In an example embodiment, when a user input extends in vertical direction, keywords along a horizontal line intersecting with the user input may be determined as a main keyword. For example, referring to FIG. 8, ‘the net movement of a substance (e.g., an atom, ion or molecule) from a region of high concentration to a region of low concentration’ and ‘Conduction is mediated by the combination of vibrations and collisions of particles’ along a horizontal line intersecting with user inputs 43a and 43b extending in vertical direction may be determined as main keywords.

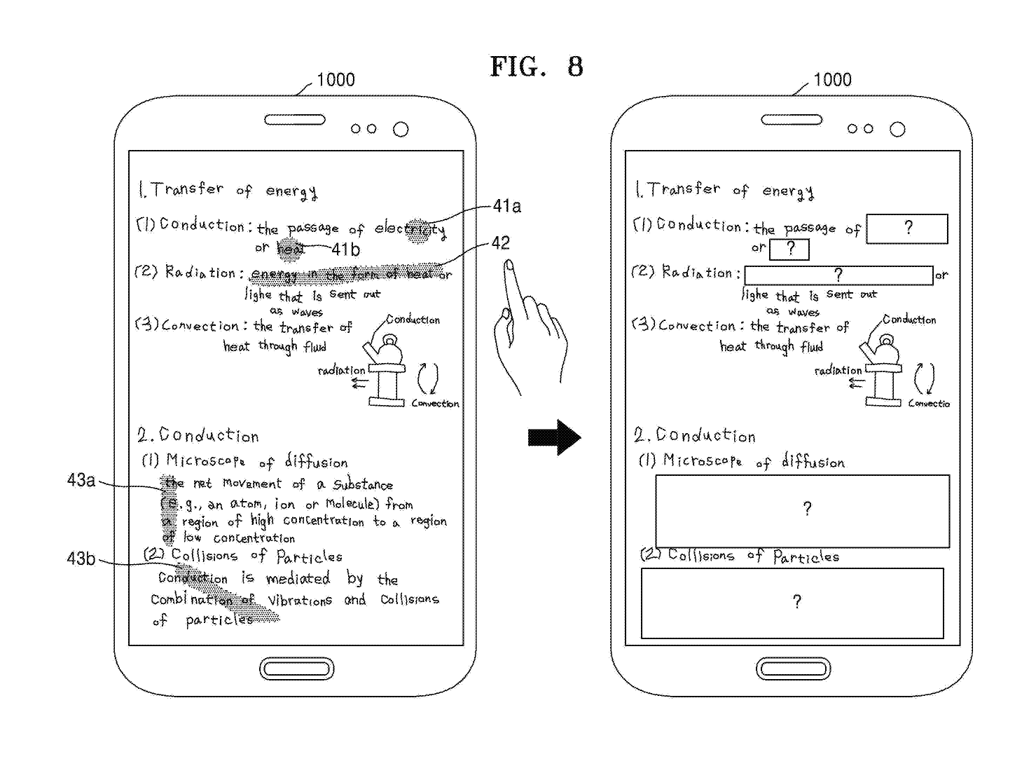

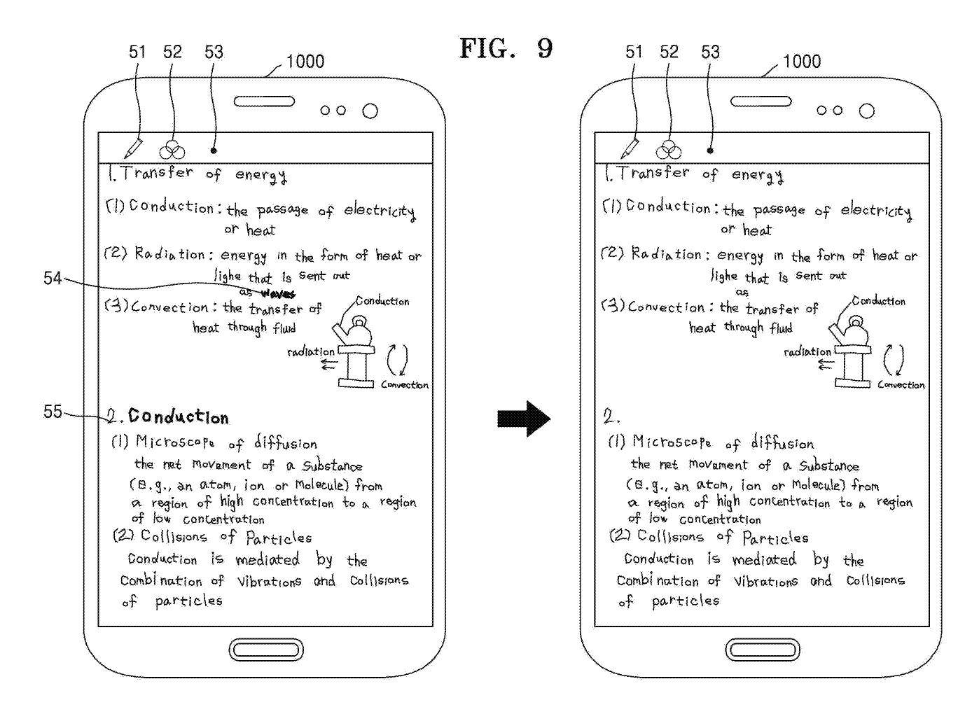

FIG. 9 is a drawing for explaining a main keyword determined based on an attribute of handwriting input by a user, according to an example embodiment.

In an example embodiment, a main keyword may be determined based on an attribute of handwriting input in handwriting data. For example, referring to FIG. 9, an attribute of handwriting input may vary according to a pen type 51, a pen color 52, and a pen thickness 53 in a user interface, but is not limited thereto.

In an example embodiment, when handwriting data consists of parts of a first and second handwriting input attribute, a part of the first handwriting input attribute may be determined as a main keyword. For example, referring to FIG. 9, ‘waves’ 54 and ‘Conduction’ 55 input by a bold pen attribute in handwriting data may be determined as main keywords.

In an example embodiment, a main keyword may be made invisible according to an input attribute after a certain time period. For example, referring to FIG. 9, ‘waves’ 54 and ‘Conduction’ 55 input by a bold pen attribute in handwriting data may be made invisible after a certain time period.

FIG. 10 is a drawing for explaining a main keyword determined based on text analysis of handwriting data, according to an example embodiment.

In an example embodiment, the handwriting data may include text data which is converted from the handwriting data. By performing text analysis on text data, a frequency or a part of speech of a certain keyword may be analyzed in the text data.

In an example embodiment, a keyword which appears more frequently than other keywords, a keyword having a certain frequency, or a keyword which is noun may be determined as a main keyword. For example, referring to FIG. 9, a keyword ‘heat’ 61, 62, or 63 which appears more frequently than other keywords and is noun may be determined as a main keyword.

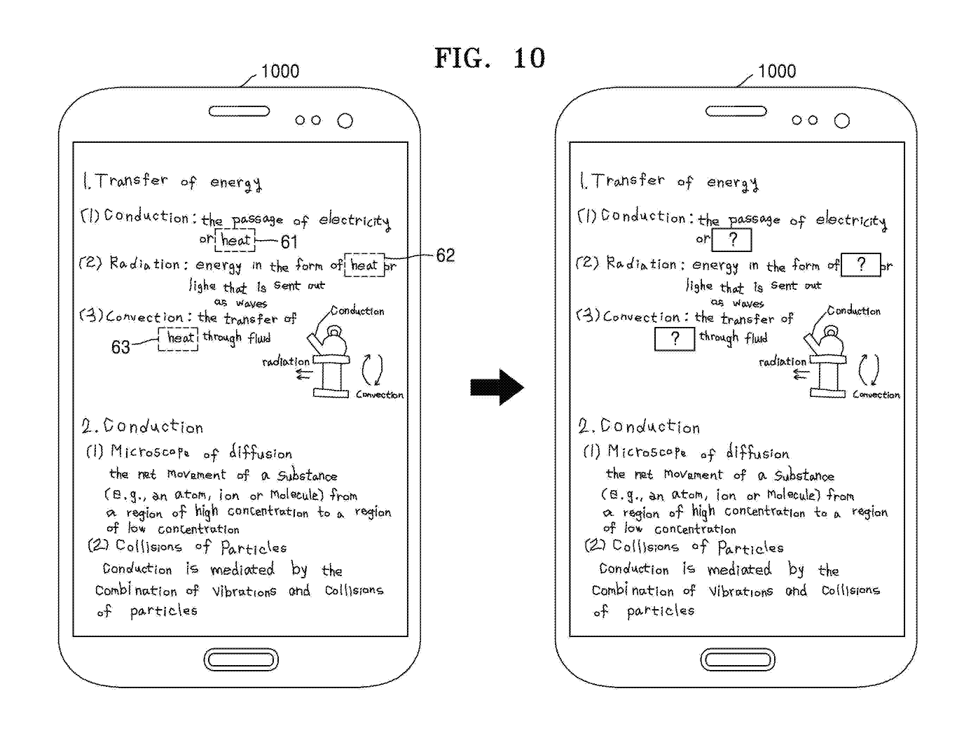

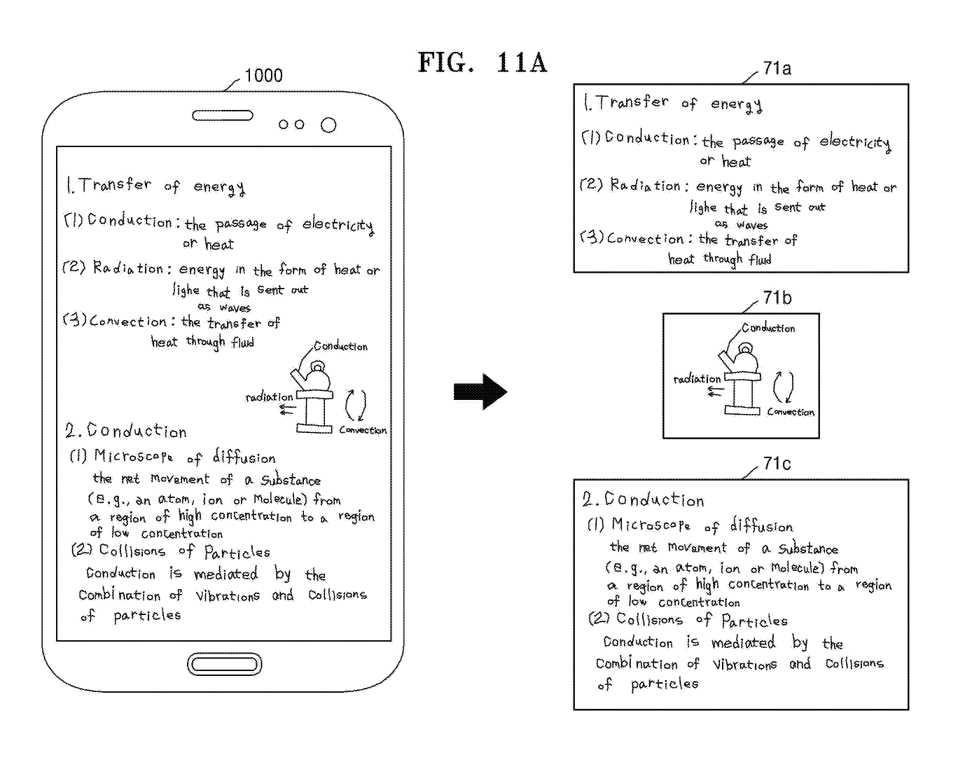

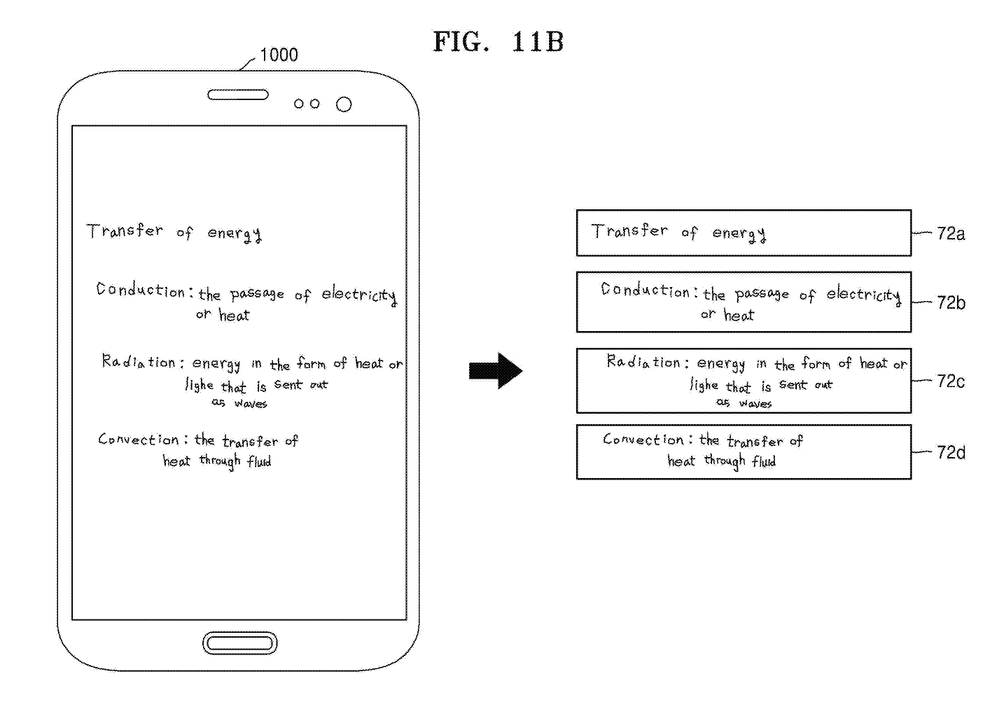

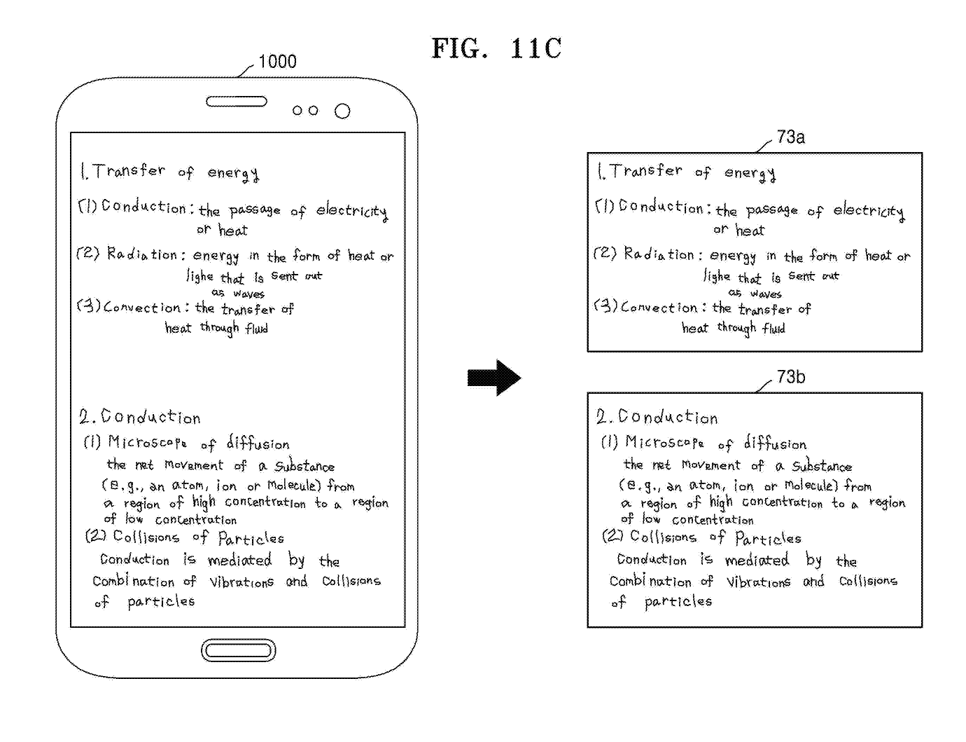

FIGS. 11A, 11B, 11C, and 11D illustrate an example of handwriting data divided into a plurality of segments, according to an example embodiment.

In an example embodiment, the handwriting data may include bullet points and drawings. In an example embodiment, the handwriting data may be divided by segments based on a bullet point, a drawing, or an empty space of a certain range.

For example, referring to FIG. 11A, handwriting data may be divided by segments 71a, 71b, and 71c based on empty spaces of a certain range.

For example, referring to FIG. 11B, each part next to each bullet point in handwriting data may be identified as segments 72a, 72b, and 72c of the handwriting data.

For example, referring to FIG. 11C, when handwriting data includes bullet points respectively having a certain level, each part starting from a bullet point of a certain level ending before a bullet point of the same level in handwriting data may be identified as segments 73a and 72b of the handwriting data.

For example, referring to FIG. 11D, each part located in a certain range from drawings 75, 76, and 77 in handwriting data may be identified as segments 74a, 72b, and 74b of the handwriting data.

In an example embodiment, a keyword located in a certain range from a drawing may be determined as a main keyword. For example, referring to FIG. 11D, ‘Conduction’, ‘Radiation’, ‘Convection’, ‘Oxygen’, ‘O²’, ‘Water’, and ‘H₂0’ near drawings 75, 76, and 77 may be determined as main keywords. The certain range for determining a main keyword may be smaller than a range for dividing handwriting data to segments.

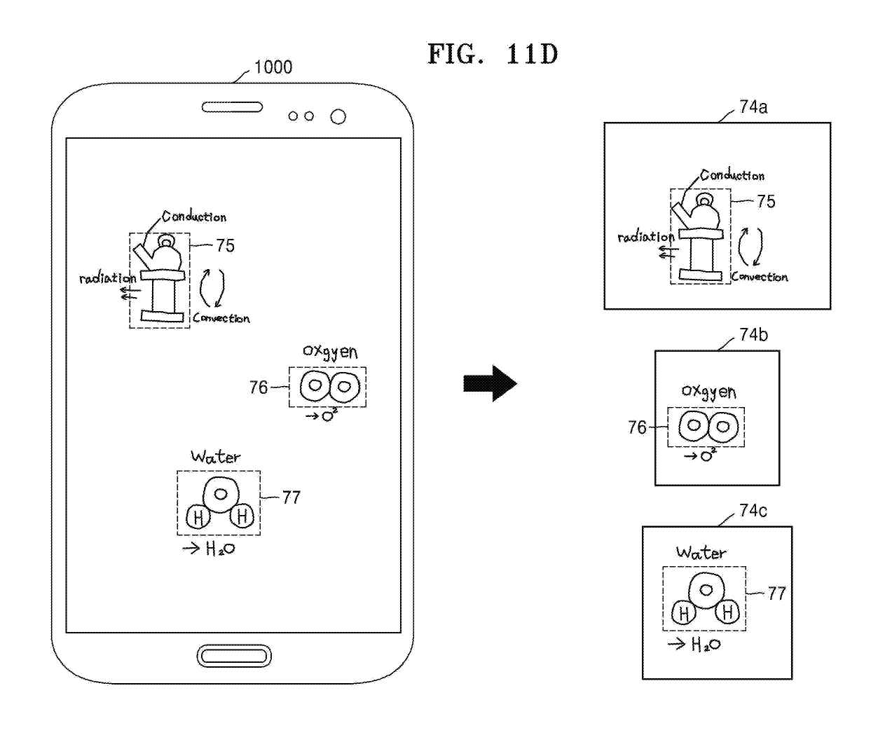

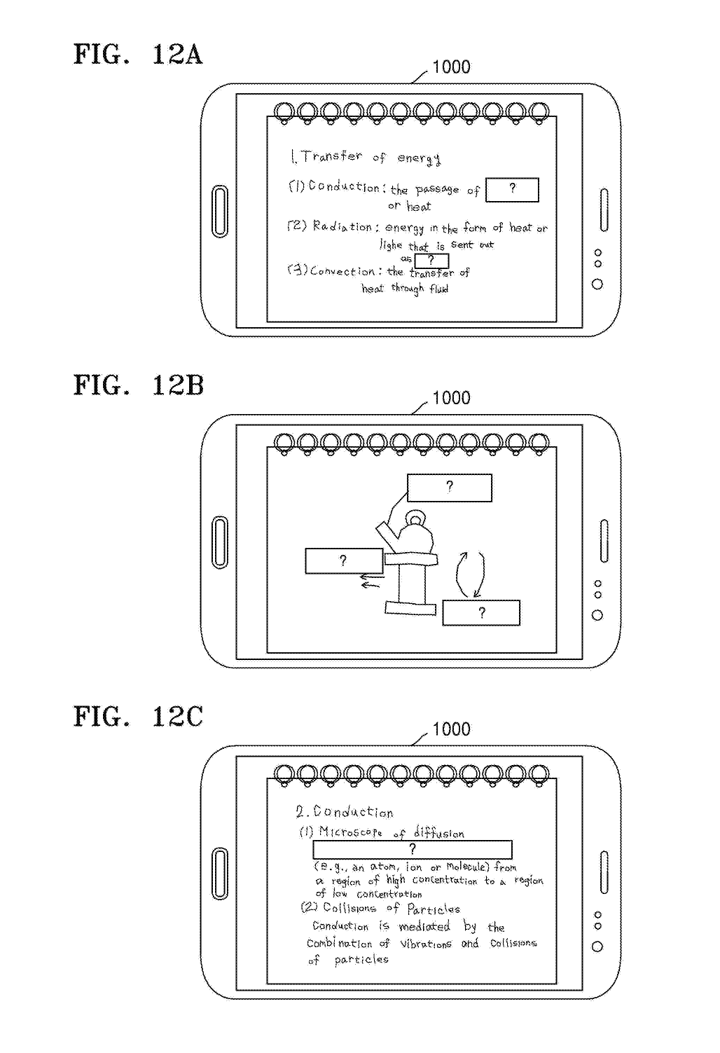

FIGS. 12A, 12B, and 12C illustrate an example question content provided based on segments.

In an example embodiment, question content may be provided according to segments. As described above, the handwriting data may be divided by a plurality of segments. Question content may be provided according to the plurality of segments. For example, referring to FIGS. 12A, 12B, and 12C, question content may be provided to a user as a type of a flashcard.

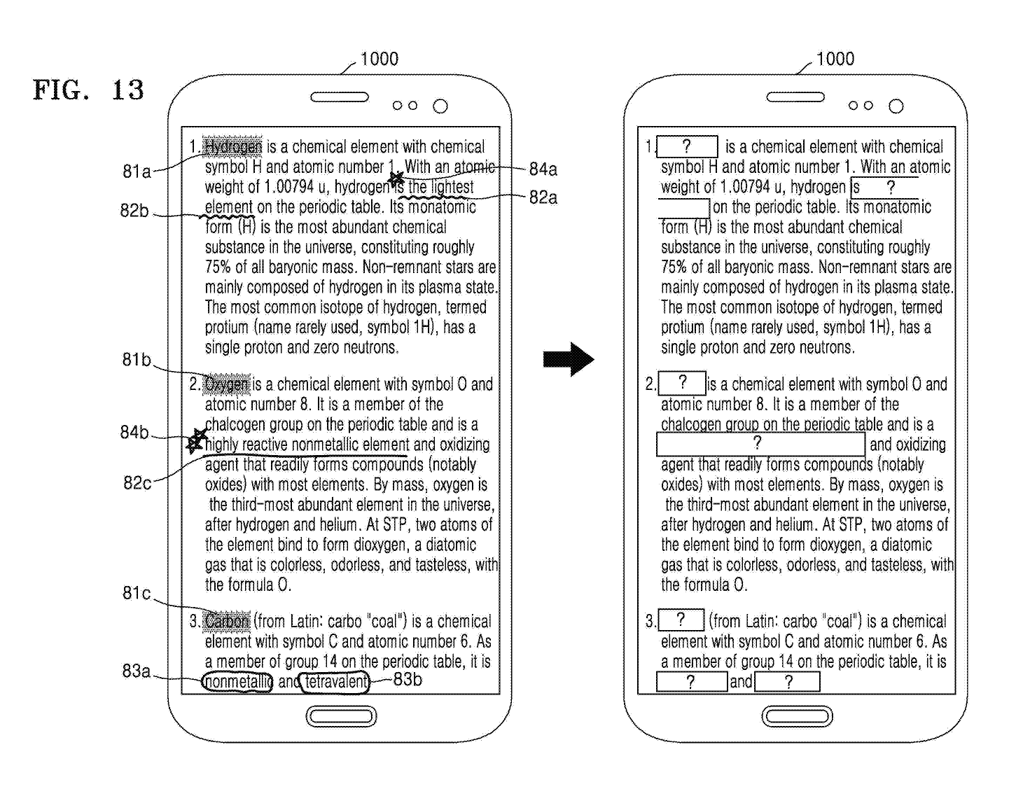

FIG. 13 is a drawing for explaining a main keyword determined from ebook content.

Referring to FIG. 13, handwriting data may be input on a loaded ebook content. The handwriting data may include highlighting. For example, highlighting may include highlights 81a, 81b, and 81c, and underlines 82a, 82b, and 82c, circles 83a and 83b, boxes, and starts 84a and 84b, but is not limited thereto. A criterion for determining a main keyword in the handwriting data is explained as above by referring FIG. 3.

Highlighting is applied to an important keyword, and the extent of highlighting may vary according to the importance of the keyword. For example, a keyword with two stars 84b may be considered as more important than a keyword with one star 84a. Accordingly, frequency of question content may be determined based on the importance of the keyword, which is expressed by the extent of highlighting.

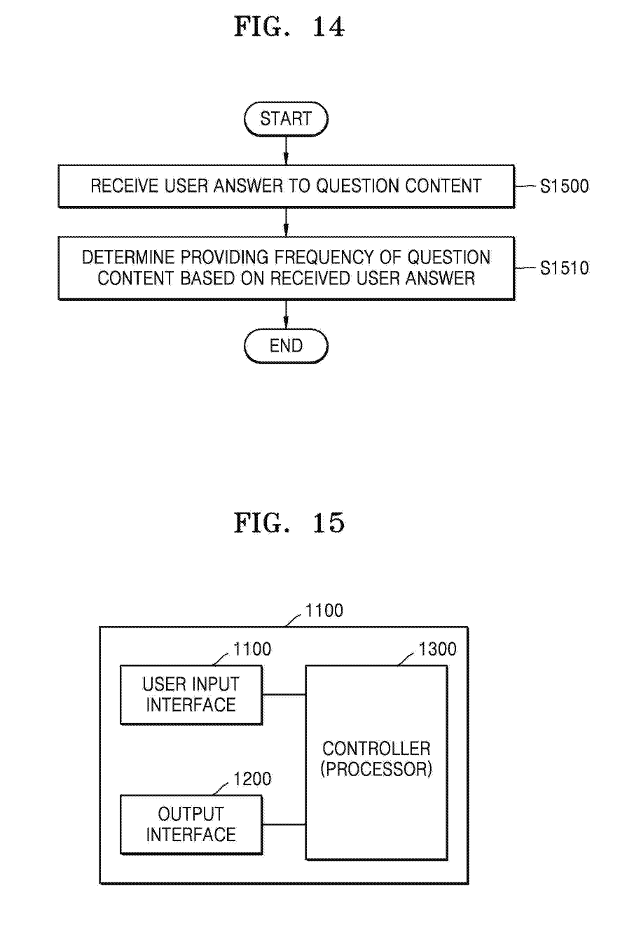

FIG. 14 illustrates a flowchart of a method of determining frequency of question content based on an answer input to the question content, according to an example embodiment.

Referring to FIG. 14, in operation S1400, a device 1000 may receive an answer input to question content by a user. The answer input may be a handwriting input, a touch input selecting an option in a multiple choice question, or a voice input, but is not limited thereto. The handwriting input and the voice input may be converted to text data.

In operation S1410, the device 1000 may determine frequency of providing question content based on the received answer input. In an example embodiment, when the answer input is a handwriting input, whether the answer input is correct may be determined by comparing strokes of the handwriting input and strokes of a main keyword. In an example embodiment, when the answer input is converted to text data, whether the answer input is correct may be determined by comparing text between the answer input and a main keyword.

In an example embodiment, frequency of providing question content may decrease if the answer input is correct, and the frequency may increase if the answer input is incorrect or response time expires.

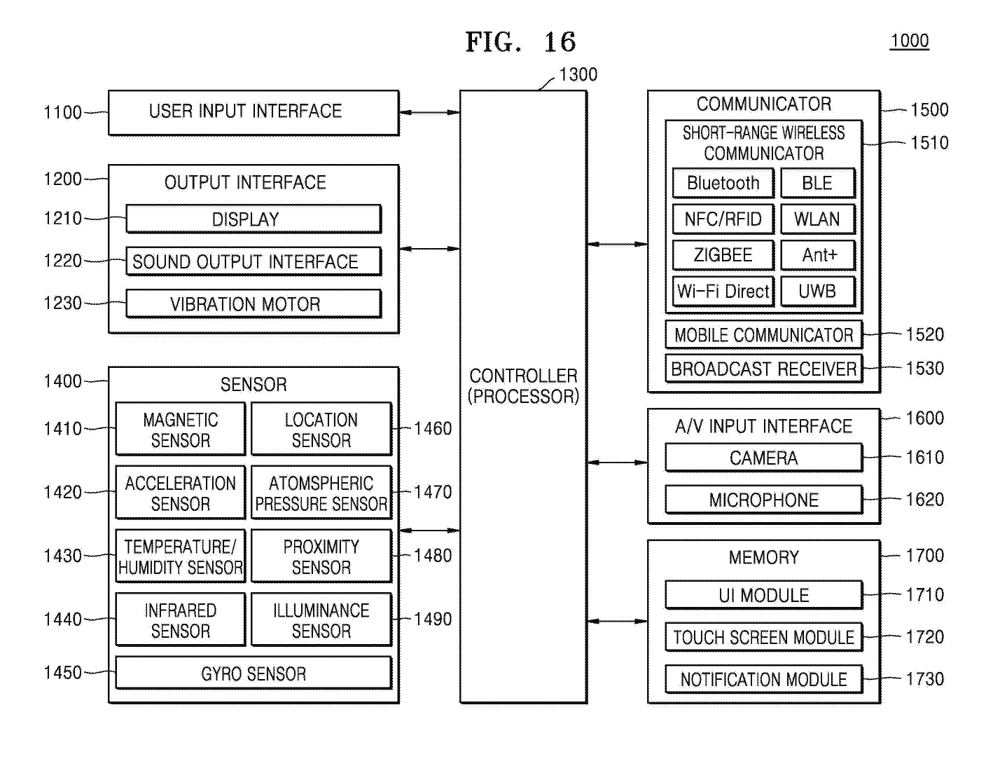

FIG. 15 and FIG. 16 illustrate an example device.

As illustrated in FIG. 15, a device 1000 may include an input interface 1100, an output interface 1200, and a processor 1300. However, all the components shown in FIG. 15 are not essential components of the device 1000. The device 1000 may be implemented by more or less components than shown in FIG. 15.

For example, as illustrated FIG. 16, the device 1000 may further include a user input interface 1100, an output interface 1200, a processor 1300, a sensor 1400, a communication interface 1500, an A/V input interface 1600, and a memory 1700.

The user input interface 1100 may be used for a user to input data to control the device 1000. For example, the user interface 1100 may be a key pad, a dome switch, a touch pad (e.g., contact electrostatic capacitive type, pressure resistive film type, infrared detection type, surface acoustic wave propagation type, integral strain gauge type, piezo-effect type, etc.), a jog wheel, and a jog switch, but not limited thereto.

The user input interface 1100 may be used for a user to input data to the device 1000.

The output interface 1200 may be used for outputting an audio signal, a video signal, or a vibration signal, and may include a display 1210, a sound output interface, and a vibration motor 1230.

The display 1210 may display information processed in the device 1000. In an example embodiment, the display 1210 may display handwriting data input by a user, and display question content provided by the processor 1300.

The display 1210 and a touch pad may be overlaid with each other to function as a touch screen, and the display 1210 may be used as not only an output device but also an input device. The display 1210 may include at least one from among a liquid crystal display, a thin-film transistor-liquid crystal display, an organic light-emitting diode, a flexible display, a 3D display, and an electrophoretic display. Furthermore, the device 1000 may include two or more displays 1210 according to embodiments. The two or more displays 1210 may be disposed to face each other across a hinge.

The sound output interface 1220 may output audio data received from the communicator 1500 or stored in the memory 1700. In an example embodiment, the sound output interface 1220 may output question content provided by the processor 1300. Furthermore, the sound output interface 1220 may output a sound signal (e.g., a call signal reception sound, a message reception sound, a notification sound, etc.) related to a function performed by the device 1000. The sound output interface 1220 may include a speaker, a buzzer, etc.

The vibration motor 1230 may output a vibration signal. For example, the vibration motor 1230 may output a vibration signal based on outputting audio or video data. The vibration motor 1230 may output a vibration signal in response to receiving a touch input.

The processor 1300 may perform various functions of the device 1000 described with FIGS. 1 through 15 by controlling overall operations of the device 1000. For example, the processor 1300 may execute programs stored in the memory 1700 to control the user input interface 1100, the output interface 1200, the sensor 1400, the communicator 1500, and the A/V input interface, etc.

The processor 1300 may acquire handwriting data input to the device 1000 by a user. The processor 1300 may acquire the handwriting data input to the device 1000 by touching a screen of the device 1000. The processor 1300 may determine a main keyword from the acquired handwriting data based on a predetermined criterion. The processor 1300 may provide question content based on the determined main keyword. The processor 1300 may provide question content in various ways. The processor 1300 may provide question content by audio.

When handwriting data includes text data which is converted from the handwriting data, text to speech (TTS) may be performed on the text data for a voice output.

In an example embodiment, question content may be selected from a question content database by comparing the determined main keyword and the question content database.

The processor 1300 may determine a keyword highlighted by a user in handwriting data as a main keyword.

The processor 1300 may determine a keyword closest to a bullet point as a main keyword.

The processor 1300 may determine a description keyword related to a main keyword from the acquired handwriting data based on a predetermined criterion. The processor 1300 may provide question content based on the determined main keyword and the determined description keyword. The processor 1300 may provide question content in various ways.

The processor 1300 may determine a keyword closest to a bullet point as a main keyword in handwriting data. The processor 1300 may determine a description keyword which is located in a predetermined range from the determined main keyword.

The processor 1300 may determine a description keyword in a description keyword database by comparing a main keyword and the description keyword database. In an example embodiment, a keyword may correspond to a plurality of indexes in a description keyword database, and an index may correspond to a plurality of keywords. In an example embodiment, a description keyword database may be included in the device 1000, but connected to the device 1000 via a network.

The processor 1300 may provide question content based on the determined main keyword and the determined description keyword. The processor 1300 may provide question content in various ways. In an example embodiment, question content may be provided as a multiple choice question. In an example embodiment, description keywords selected from a description keyword database may be used as options in a multiple choice question for a main keyword. In an example embodiment, main keywords may be used as options in a multiple choice question for a description keyword selected from a description keyword database.

The processor 1300 may determine a keyword selected by a user in handwriting data as a main keyword.

In an example embodiment, the processor 1300 may determine a main keyword based on an attribute of handwriting input in handwriting data.

The processor may convert handwriting data to text data. By performing text analysis on the converted text data, a frequency or a part of speech of a certain keyword may be analyzed in the text data.

In an example embodiment, the handwriting data may be divided by segments based on a bullet point, a drawing, or an empty space of a certain range.

The processor 1300 may determine a main keyword located in a certain range from a drawing in handwriting data. The certain range for determining a main keyword may be smaller than a range for dividing handwriting data to segments.

The processor 1300 may provide question content according to segments. For example, question content may be provided to a user as a type of a flashcard.

The processor 1300 may load ebook content, and receive handwriting data input by a user. The handwriting data may include highlighting. The processor 1300 may determine a keyword highlighted by a user in handwriting data as a main keyword.

The processor 1300 may receive an answer input to question content. The answer input may be received by the user input interface 1100 or the microphone 1620.

The processor 1300 may determine frequency of providing question content based on the received answer input. In an example embodiment, when the answer input is a handwriting input, whether the answer input is correct may be determined by comparing strokes of the handwriting input and strokes of a main keyword. In an example embodiment, when the answer input is converted to text data, whether the answer input is correct may be determined by comparing text between the answer input and a main keyword.

The sensor 1400 may sense a state of or ambient state of the device 1000 and transmit a result of the sensing to the processor 1300.

The sensor 1400 may include at least one from among a magnetic sensor 1410, an acceleration sensor 1420, a temperature/humidity sensor 1430, an infrared sensor 1440, a gyroscope 1450, a location sensor 1460 such as a GPS, an atmospheric pressure sensor 1470, a proximity sensor 1480, and a illuminance sensor 1490, but not limited thereto. A function of each sensor would be intuitively inferred by those of ordinary skill in the art, and detailed explanation thereof is omitted in this disclosure.

The communication interface 1500 may include at least one element for establishing communication with other devices. For example, the communicator 1500 may include a short-range communicator 1510, a mobile communicator 1520, and a broadcast receiver 1530.

The short-range communicator 151 may include a BLUETOOTH communicator, a BLUETOOTH Low Energy (BLE) communicator, a Near Field Communicator, a WLAN communicator, a ZigBee communicator, an Infrared Data Association communicator, a Wi-Fi Direct communicator, a Ultra WideBand communicator, an Ant+ communicator, a Z-wave communicator, etc.

The mobile communicator 1520 may communicate a wireless signal with at least one from among a base station, an external terminal, and a server via a mobile communication networks. The wireless signal may include a voice call signal, a video call signal, or any types of data to communicate a text/multimedia message.

The broadcast receiver 1530 may receive a broadcasting signal and/or broadcast-related information from the outside via a broadcasting channel. The broadcasting channel may include a satellite channel, a terrestrial channel, etc. The device 1000 may not include the broadcast receiver 1530 according to embodiments.

The communicator 1500 may communicate with an external device to modify handwriting data.

The A/V input interface 1600 may include a camera 1610 and a microphone 1620 to receive an audio signal or a video signal. The camera 1610 may acquire a image frame such a still image or a video by an image sensor in a video call mode or a capturing mode. Images captured by the image sensor may be processed by the processor 1300 or an image processor.

Images processed by the camera 1610 may be stored in the memory 1700, or transmitted to the outside through the communicator 1500. The device 1000 may include two or more cameras 1610 according to embodiments.

The microphone 1620 may receive and process a sound signal from the outside to convert it to an electronic sound data. For example, the microphone 1620 may receive a sound signal from an external device or a speaker. The microphone 1620 may employ any of various noise-reduction algorithms to reduce noise occurring while receiving a sound signal from the outside. The microphone 1620 may receive an answer input to question content.

The memory 1700 may store programs for processing and controlling of the processor 1300, and store data inputted to or outputted from the device 1000.

The memory 1700 may include at least one from among a flash memory type memory, a hard disk type memory, a multimedia card micro type memory, a card type memory (e.g., a secure digital (SD) memory, an extreme digital (XD) memory, etc.), a random access memory (RAM), a static RAM (SRAM), a read-only memory (ROM), a programmable ROM (PROM), an electrically erasable PROM (EEPROM), a magnetic memory, a magnetic disk, and an optical disc.

Programs stored in the memory 1700 may be classified into a plurality of modules such as a UI module 1710, a touch screen module 1720, and a notification module 1730 according to embodiments.

The UI module 1710 may provide a UI or a GUI according to each application to interact with the device 1000. The touch screen module 1720 may detect a user's touch gesture on a touch screen and transmit information regarding the touch gesture to the processor 1300. The touch screen module 1720 according to one exemplary embodiment may recognize and analyze touch codes. The touch screen module 1720 may be embodied as hardware including a processor.

A sensor may be employed in or near the touch screen to detect a touch or a proximity touch on or above the touch screen. The sensor employed to detect a touch may be a tactile sensor. The tactile sensor may sense a contact of an object to a certain extent, the extent being equal to or more than humans do. The tactile sensor may detect various information such as a roughness of a contact surface, hardness of a contacting object, and a temperature at a contact point.

The sensor employed to detect a touch may be a proximity sensor.

The proximity sensor may detect an object approaching or near a detection surface without a physical contact by using the force of an electromagnetic field or an infrared ray. The proximity sensor may be a transmissive photoelectric sensor, a direct reflective photoelectric sensor, a mirror reflective photoelectric sensor, a high-frequency oscillation proximity sensor, a capacitive proximity sensor, a magnetic proximity sensor, and an infrared proximity sensor, but not limited thereto. The touch gesture may include a tap, a touch and hold gesture, a double tap, dragging, panning, a flick, a drag and stop gesture, a swipe, or so on.

The notification module 1730 may generate a signal for notifying an occurrence of an event at the device 1000. The event occurring at the device 1000 may include a call signal reception, a message reception, a key signal reception, a schedule notification, etc. The notification module 1730 may output a notification signal through the display unit 1210 in the form of a video signal, through the sound output unit 1220 in the form of a sound signal, or though the vibration motor 1230 in the form of a vibration signal.

Each component of, or at least a part of the device 1000 may be embodied by at least one hardware processor. For example, handwriting data may be acquired by a processor different from a main processor of the device 1000. Each component of, or at least a part of the device 1000 may be embodied by at least one software program module. For example, a function of the device 1000 may be embodied by an operating system or an application program. Accordingly, functions of the device 1000 may be embodied by a combination of hardware and software.

Various embodiments of the present disclosure may be embodied as on a computer readable recording medium including computer readable codes such as a program module executable at a computer. A computer readable recording medium may be volatile, non-volatile, or a combination of volatile and non-volatile, where appropriate. The computer readable recording medium includes a computer storage medium and communication medium. The computer storage medium may include a computer readable instruction, a data structure, a program module, or any medium, but is not limited thereto. The communication medium may include any information transmission medium such as a carrier wave.

While the present disclosure has been particularly shown and described with reference to exemplary embodiments thereof, it will be understood by those of ordinary skill in the art that various changes in form and details may be made therein without departing from the spirit and scope as defined by the following claims. That is, described embodiments are exemplary and should be understood as not limiting the scope defined by the claims. For example, each function may be performed in a distributed way or a combined way.

Disclosed embodiments may have different forms and should not be construed as being limited to the descriptions set forth herein. Rather, these embodiments are provided so that this disclosure will be thorough and complete and will fully convey the concept of the embodiments to one of ordinary skill in the art.

1. A method of providing a user with question content, the method comprising:
acquiring handwriting data input by a user to a screen of a device;
determining at least one main keyword from the handwriting data based on a predetermined criterion; and
providing the user with the question content based on the determined at least one main keyword.

2. The method of claim 1, wherein the determining of the at least one main keyword comprises:
determining, as the at least one main keyword, at least one keyword highlighted by the user among keywords included in the acquired handwriting data.

3. The method of claim 1, wherein
the acquired handwriting data comprises at least one bullet point, and
the determining of the at least one main keyword comprises determining, as the at least one main keyword, at least one keyword located within a predetermined range of the at least one bullet point.

4. The method of claim 3, wherein the method further comprises:
determining at least one description keyword related to the determined at least one main keyword from the acquired handwriting data based on a predetermined criterion, and
the question content is provided based on the determined at least one main keyword and the determined at least one description keyword.

5. The method of claim 4, wherein
the acquired handwriting data comprises at least one punctuation mark, and
the determining of the at least one description keyword comprises determining, as the at least one description keyword, at least one keyword located within a predetermined range of the at least one punctuation mark.

6. The method of claim 1, wherein the method further comprises:
retrieving at least one description keyword related to the determined at least one main keyword from a description keyword database by comparing the determined at least one main keyword and the description keyword database, and
the question content is provided based on the determined at least one main keyword and the selected description keyword.

7. The method of claim 1, wherein
the question content is retrieved from a question content database by comparing the determined at least one main keyword and the question content database.

8. The method of claim 1, wherein
the acquired handwriting data is divided into a plurality of segments based on a predetermined criterion, and
the question content is provided based on the plurality of segments.

9. The method of claim 1, wherein
the handwriting data is input to loaded ebook content, and
the determining of the at least one main keyword comprises determining, as the at least one main keyword, at least one keyword highlighted by the user in the ebook content.

10. The method of claim 1, wherein
the determining of the at least one main keyword comprises:
determining the at least one main keyword based on an attribute of handwriting in the acquired handwriting data.

11. The method of claim 1, wherein
the providing of the question content comprises:
making invisible the determined at least one main keyword.

12. The method of claim 1, further comprising:
receiving, from the user, an answer input in answer to the question content; and
determining a frequency of providing the question content based on the answer input of the user.

13. The method of claim 1, further comprising:
determining a frequency of providing the question content based on an attribute of the determined at least one main keyword.

14. A device for providing a user with question content, the device comprising:
a user input interface configured to acquire handwriting data input by a user to a screen of the device;
a processor configured to: determine at least one main keyword from the handwriting data based on a predetermined criterion; and provide the user with the question content based on the determined at least one main keyword.

15. A computer-readable recording medium having recorded thereon a program for executing the method of claim 1 on a computer.
